(19) United States
(12) Patent Application Publication
(10) Pub. No.: US 2026/0080252 A1
(43) Pub. Date: Mar. 19, 2026

(54) MACHINE LEARNING APPARATUS, METHOD, AND STORAGE MEDIUM

(71) Applicant: KABUSHIKI KAISHA TOSHIBA, Kawasaki-shi Kanagawa (JP)

(72) Inventors: Kazuki UEMATSU, Fuchu Tokyo (JP); Hideyuki NAKAGAWA, Kawasaki Kanagawa (JP); Takahiro TAKIMOTO, Yokohama Kanagawa (JP)

(73) Assignee: KABUSHIKI KAISHA TOSHIBA, Kawasaki-shi Kanagawa (JP)

(21) Appl. No.: 19/314,802

(22) Filed: Aug. 29, 2025

(30) Foreign Application Priority Data
Sep. 18, 2024 (JP) 2024-161209

(51) Int. Cl. G06N 3/09

(52) U.S. Cl. CPC G06N 3/09

(57) ABSTRACT

According to one embodiment, a machine learning apparatus comprising a processor. The processor acquires, by applying a first sample to a first deep learning model that processes a classification problem, a first model output containing an inference probability and/or a feature vector output. The processor determines whether an update of a label to be used as a teacher in learning of the first deep learning model is required, based on the first model output and/or the label. The processor updates the label based on the first model output and a label at a current number of updates if it is determined that the update of the label is required, and terminates the update of the label if it is determined that the update of the label is not required.

### CROSS-REFERENCE TO RELATED APPLICATION

This application is based upon and claims the benefit of priority from Japanese Patent Application No. 2024-161209, filed Sep. 18, 2024, the entire contents of which are incorporated herein by reference.

### FIELD

Embodiments described herein relate generally to a machine learning apparatus, a method, and a storage medium.

### BACKGROUND

Machine learning, and deep learning models in particular, have spread to various fields over the past decade. Especially for classification problems, unsupervised learning, which does not require manually added target labels, has also spread. However, since the use of target labels generally demonstrates higher performance, supervised learning is mainly used in a case where high reliability is required. However, in a case where the cost of labeling is very high, such as a medical system requiring extremely high expertise to add reliable labels or a manufacturing line that needs to process an enormous amount of data, wrong labels are inevitably contained in labels manually added. That is, although the use of target labels was originally intended to improve reliability, it can actually cause a significant deterioration in model performance. In order to prevent such a situation, it is required to make a deep learning model robust against wrong labels, assuming that some errors are contained even after efforts to reduce wrong labels.

### BRIEF DESCRIPTION OF DRAWINGS

FIG. 1 is a diagram showing a configuration example of a machine learning apparatus according to the present embodiment.

FIG. 2 is a diagram showing a functional configuration of a label correction unit.

FIG. 3 is a flowchart showing an example of a label correction process by the label correction unit.

FIG. 4 is a diagram showing a relationship between a transition of an inference probability and the number of truncated updates.

FIG. 5 is a diagram showing a functional configuration of a learning rate estimation unit.

FIG. 6 is a flowchart showing an example of a learning rate determination process by the learning rate estimation unit.

FIG. 7 is a diagram showing behavior of an inference probability at a plurality of learning rates.

FIG. 8 is a diagram showing a deviation-learning rate graph.

FIG. 9 is a flowchart showing an example of an overall process by the machine learning apparatus.

FIG. 10 is a diagram showing transition of an accuracy of pseudo labels according to a comparative example.

FIG. 11 is a diagram showing transition of an accuracy of pseudo labels according to the present embodiment.

### DETAILED DESCRIPTION

A machine learning apparatus according to an embodiment includes a training unit, a determination unit, and an update unit. The training unit acquires, by applying a first sample to a first deep learning model that processes a classification problem, a first model output containing an inference probability and/or a feature vector output from the first deep learning model. The determination unit determines whether an update of a label to be used as a teacher in learning the first deep learning model is required, based on the first model output and/or the label. The update unit updates the label based on the first model output and a label at a current number of updates if it is determined that the update of the label is required, and terminates the update of the label if it is determined that the update of the label is not required.

Hereinafter, a machine learning apparatus, a method, and a storage medium according to the present embodiment will be described with reference to the drawings.

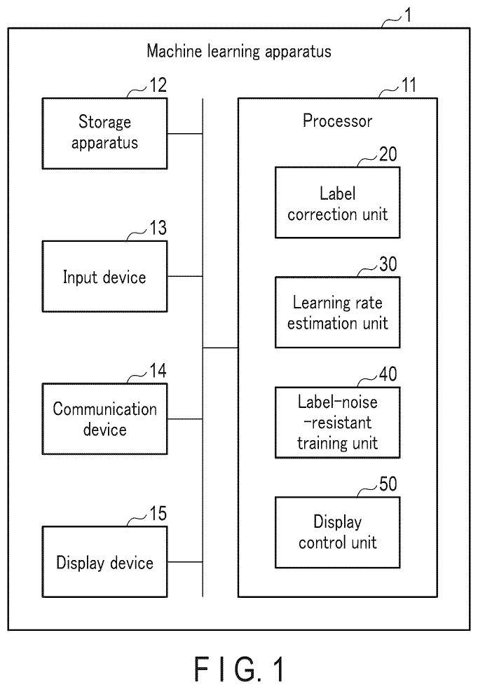

FIG. 1 is a diagram showing a configuration example of a machine learning apparatus 1 according to the present embodiment. As shown in FIG. 1, the machine learning apparatus 1 includes a processor 11, a storage apparatus 12, an input device 13, a display device 15, and a communication device 14. Data and various signals are transmitted and received between the processor 11, the storage apparatus 12, the input device 13, the display device 15, and the communication device 14 via a bus.

The processor 11 is an integrated circuit that controls the overall operation of the machine learning apparatus 1. For example, the processor 11 includes a central processing unit (CPU), a graphics processing unit (GPU), a digital signal processor (DSP), and/or a floating-point unit (FPU). The processor 11 may include an internal memory and an I/O interface. The processor 11 performs various processes by interpreting and calculating a program stored in advance in the storage apparatus 12 or the like. Note that a part or all of the processor 11 may be implemented by hardware such as an application specific integrated circuit (ASIC) or a field programmable gate array (FPGA).

The storage apparatus 12 is a volatile memory and/or a nonvolatile memory that stores various types of data. For example, the storage apparatus 12 stores data and setting values to be used by the processor 11 to perform various processes, data generated in various processes by the processor 11, and the like. The storage apparatus 12 is constituted by a read only memory (ROM), a random access memory (RAM), a hard disk drive (HDD), a solid state drive (SSD), an integrated circuit storage apparatus, and the like. Note that the storage apparatus 12 may include a non-transitory computer-readable storage medium that stores a program to be executed by the processor 11.

The input device 13 receives inputs of various operations from an operator. As the input device 13, a keyboard, a mouse, various switches, a touch pad, a touch panel display, and the like can be used. An electrical signal corresponding to the received input of an operation (hereinafter, an operation signal) is supplied to the processor 11.

The display device 15 displays various types of data under the control of the processor 11. As the display device 15, a cathode-ray tube (CRT) display, a liquid crystal display, an organic electro luminescence (EL) display, a light-emitting diode (LED) display, a plasma display, or any other display can be appropriately used. The display device 15 may be a projector.

The communication device 14 includes a communication interface, such as a network interface card (NIC), for performing data communication with various devices connected to the machine learning apparatus 1 via a network. Note that an operation signal may be supplied from a computer connected via the communication device 14 or an input device included in the computer, and various types of data may be displayed on a display device or the like included in a computer connected via the communication device 14. However, in order to simplify the following description, unless otherwise specified, it is assumed that the input device 13 is the source of operation signals, and the display device 15 is the display destination of various types of data. The input device 13 can be replaced with a computer connected via the communication device 14 or an input device included in the computer, and the display device 15 can be replaced with a display device or the like included in a computer connected via the communication device 14.

The machine learning apparatus 1 does not need to include all of the processor 11, the storage apparatus 12, the input device 13, the display device 15, and the communication device 14. If necessary, some of the storage apparatus 12, the input device 13, the display device 15, and the communication device 14 may not be provided. The machine learning apparatus 1 may be provided with any additional hardware device useful for performing the processes according to the present embodiment. The machine learning apparatus 1 does not need to be physically configured by a computer, and may be configured by a computer system including a plurality of computers communicably connected via a wired or network line or the like. The allocation of a series of processes according to the present embodiment to the processors 11 mounted on the respective computers can be set arbitrarily. All of the processors 11 may perform all of the processes in parallel, or a specific process may be allocated to one or some of the processors 11, and the series of processes according to the present embodiment may be performed as the entire computer system.

The processor 11 performs supervised learning on a deep learning model that processes a classification problem. In supervised learning, a target label is used as a teacher to compare inference probabilities output from the deep learning model in response to input of a sample. As described above, the target label is manually added after a human grasps the content of the sample, or automatically added by a computer after a computer analyzes the content of the sample. Therefore, the target label may inevitably contain an error (noise). Hereinafter, a label including an error is referred to as a noisy label. Robust deep learning against the noisy label is required.

Countermeasures against the noisy label have been actively studied as a learning method in a case where a target label contains noise. Currently, the mainstream approach is to select reliable labeled data, perform relabeling, and introduce loss functions that incorporate their effects. In particular, Non-patent Literature 1 (Sheng Liu, Jonathan Niles-Weed, Narges Razavian, and Carlos Fernandez-Granda, “Early-Learning Regularization Prevents Memorization of Noisy Labels,” Advances in Neural Information Proceeding Systems 33 (NeurIPS 2020)) proposes a method of improving the reliability of labels, that is, performing relabeling by correcting training labels y using inferred labels p in an exponential moving average manner, such as y←mp+ (1−m)y. Note that m is a hyperparameter and is about 0.01 to 0.1. In this method, a soft label is used as a pseudo label which is a target label after relabeling, and a label with high precision can be stably obtained as compared to a case where a hard label is used. However, this method is very sensitive to the number of label updates, and it has been verified by the inventor that the precision of pseudo labels is greatly deteriorated if the number of updates is too small or too large.

The processor 11 generates a highly reliable target label to ensure the reliability of the target label to be used as a teacher in learning a deep learning model that processes a classification problem (hereinafter, a classification model). The processor 11 then uses the highly reliable target label to perform deep learning robust against the noisy label. As a functional configuration therefor, the processor 11 includes a label correction unit 20, a learning rate estimation unit 30, a label-noise-resistant training unit 40, and a display control unit 50, as shown in FIG. 1.

The label correction unit 20 generates a highly reliable target label to be used as a teacher in learning the classification model by correcting an initial label. The initial label is a target label before correction (before update), and can be the same (correct label) as the true label of a sample or can be different (wrong label) from the true label of the sample. The label is corrected by iteratively updating the initial label based on a model output from the deep learning model. Updating a label is also referred to as relabeling. The label correction unit 20 generates a highly reliable target label by appropriately controlling the number of updates. The generated highly reliable target label is referred to as an optimal target label.

The learning rate estimation unit 30 estimates an optimal learning rate for relabeling. The optimal learning rate means a learning rate that maintains a balance between suppressing overfitting and improving the accuracy. The estimated optimal learning rate is referred to as an optimal learning rate. The optimal learning rate is used for label update (relabeling) by the label correction unit 20. In addition, the optimal learning rate may be used for machine learning by another computer connected via the communication device 14.

The label-noise-resistant training unit 40 performs supervised learning on the classification model. At this time, the label-noise-resistant training unit 40 may perform supervised learning using the optimal target label obtained by the label correction unit 20 as a teacher. As a result, supervised learning robust to label noise is achieved.

The display control unit 50 displays various types of information on the display device 15. As an example, the display control unit 50 displays the sample, the optimal target label, information to be used for generating the optimal target label, an optimal learning rate, information to be used for estimating the optimal learning rate, and the like.

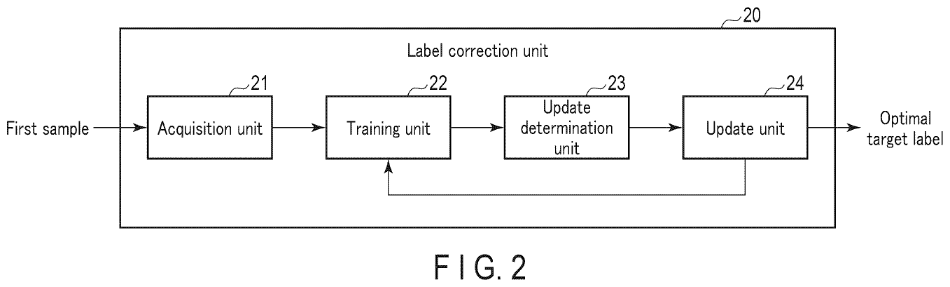

FIG. 2 is a diagram showing a functional configuration example of the label correction unit 20. As shown in FIG. 2, the label correction unit 20 includes an acquisition unit 21, a training unit 22, an update determination unit 23, and an update unit 24.

The acquisition unit 21 acquires a first sample. The first sample means data to be input to a first classification model, and contains any format of data applicable to the classification model, such as images, video, audio, text, sensor output, and the like.

The training unit 22 acquires a first model output from the first classification model by processing the first sample. The first model output contains an inference probability and/or a feature vector output from the first classification model. The inference probability is a final output calculated by the first classification model, and is a vector having the number of components (number of dimensions) according to the number of classes. Each component has a value corresponding to the probability of the corresponding class. The inference probability can also be expressed as a label calculated by the first classification model. The inference probability is calculated as a soft label. The soft label means a label in which each component value is given as a continuous value. A hard label means a label in which each component value is given as a one-hot representation of 1 or 0. The feature vector is an intermediate output of the first classification model, and is a vector having an arbitrary number of components.

The update determination unit 23 determines whether a target label, to be used as a teacher in learning the first classification model, is required to be updated or not based on the first model output acquired by the training unit 22 and/or the target label. More specifically, the update determination unit 23 calculates a first number of updates related to a stop of the update of the target label (hereinafter, the number of truncated updates) based on the first model output and/or the target label. The update determination unit 23 determines whether the update of the target label is required based on a comparison between the current number of updates and the number of truncated updates. The number of updates means the number of times the target label is updated, and is synonymous with the number of epochs.

The update unit 24 updates the target label based on the first model output and the target label at the current number of updates if the update determination unit 23 determines that the update of target label is required, and terminates the update of the target label if the update determination unit 23 determines that the update of target label is not required. If it is determined that the update of the target label is not required, the update unit 24 terminates the update of the target label and corrects the target label at the current number of updates to a hard-labeled one-hot label. The corrected one-hot label is used as the optimal target label.

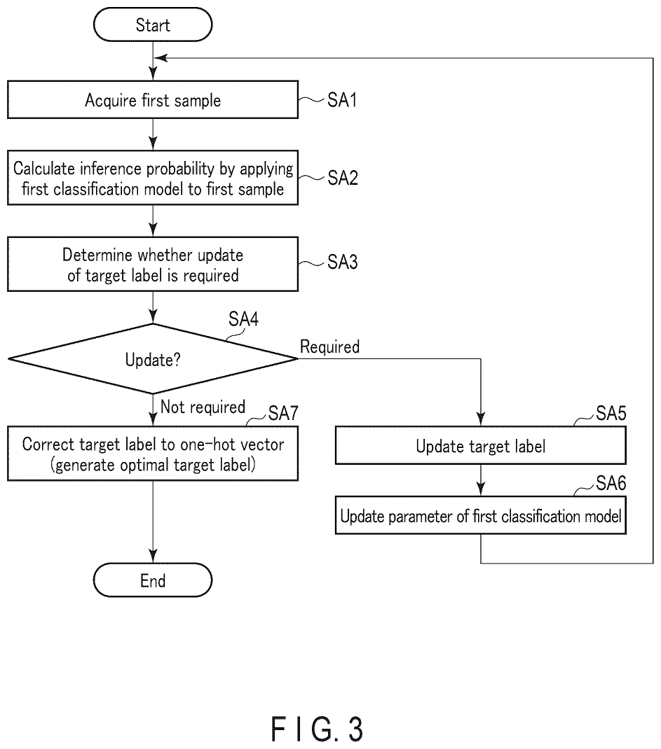

FIG. 3 is a flowchart showing an example of a label correction process by the label correction unit 20. As shown in FIG. 3, first, the acquisition unit 21 acquires a first sample (step SA1). The first sample is acquired from a first learning data set containing a plurality of first samples. In step SA1, the first samples for one mini-batch are acquired. The first samples are each provided with a target label. Here, the initial value of the target label is also referred to as an initial label. The initial label is assumed to be a noisy label that does not match the true label of the first sample.

When step SA1 is performed, the training unit 22 calculates an inference probability by applying a first classification model to the first sample acquired in step SA1 (step SA2). The first classification model is assumed to be a deep neural network (DNN) with any network layer such as a fully-connected layer, a convolutional layer, a self-attention layer, and/or a pooling layer. The first classification model is untrained. The training unit 22 inputs the first sample to the first classification model, and applies a forward propagation process according to the network structure of the first classification model to the input first sample, thereby calculating the inference probability corresponding to the first sample.

When step SA2 is performed, the update determination unit 23 determines whether the update of the target label is required (step SA3). In step SA3, the update determination unit 23 determines whether the update of the target label is required based on a comparison between the number of truncated updates calculated in advance and the current number of updates. More specifically, the update determination unit 23 determines that the update of target label is required if the current number of updates has not reached the number of truncated updates, and determines that the update of target label is not required if the current number of updates has reached the number of truncated updates. The number of updates means the number of times the target label has been updated in step SA5. The number of truncated updates means the number of updates that the update of the target label has been truncated. The calculation of the number of truncated updates will be described later.

If it is determined in step SA3 that the update of target label is required (step SA4: required), the update unit 24 updates the target label related to the first sample (step SA5). As an example, the update unit 24 calculates a target label y′ at the next number of updates based on an inference probability p at the current number of updates and a target label y at the current number of updates according to the following expression (1). In the expression, m is a hyperparameter and can be set to any value. As an example, m may be set from 0.01 to 0.1. The target label obtained by label update is also referred to as a pseudo label. In this manner, the update unit 24 calculates the moving average of the target label y as the target label y′. As the moving average, a simple moving average, a weighted moving average, an exponential moving average, or any other moving average can be used.

$${y}^{′} ← mp + ( 1 - m ) y \qquad ( 1 )$$

When step SA5 is performed, the training unit 22 updates a parameter of the first classification model (step SA6). In step SA6, the training unit 22 calculates a loss for evaluating an error between the inference probability calculated in step SA2 and the target label obtained in step SA5 according to a predetermined loss function, and updates the parameters of the first classification model to decrease the calculated loss. The parameters are assumed to be a weight or bias in each network layer of the first classification model. As a parameter optimization algorithm, any method such as Stochastic gradient descent (SGD) or Adam is only required to be used. Note that the optimal learning rate estimated by the learning rate estimation unit 30 is preferably used as the learning rate.

Note that the number of truncated updates is set for each first sample. Therefore, the update determination unit 23 determines whether the update of the target label is required based on a comparison between the number of truncated updates and the current number of updates for each first sample, and the update unit 24 updates the target label for each first sample.

When step SA6 is performed, steps SA1 to SA6 are repeated for all the first samples until it is determined in step SA3 that the update is not required. In step SA1, an unprocessed mini batch is acquired from the data set. If there is no more unprocessed mini batch, steps SA1 to SA6 are repeated for each mini batch again. One round of mini batches is called an epoch. The number of updates is synonymous with the number of epochs.

Then, if it is determined in step SA3 that the update is not required (step SA4: Not required), the update unit 24 corrects the target label at the current number of updates to a one-hot vector (step SA7). Specifically, the update unit 24 corrects the maximum value among a plurality of component values constituting the target label to 1, and corrects the other component values to 0 for each first sample. By correcting the pseudo label at the current number of updates to the one-hot vector in this manner, the optimal target label is generated.

When step SA7 is performed, the label correction process by the label correction unit 20 is terminated.

Here, a method of calculating the number of truncated updates by the update determination unit 23 will be described in detail. In a case where a deep learning model is optimized using Stochastic gradient descent, the update determination unit 23 utilizes a property that overfitting to a wrong label does not occur if the learning rate is sufficiently high during learning. In the present embodiment, this property is referred to as a generalizability. If the learning rate is high enough to acquire generalizable features, it is expected that the inference probability is static after a certain number of updates. That is, under the assumption of generalizability, if the one-hot representation of the pseudo label changes from the one-hot representation of the initial label, it can be considered that the initial label is wrong.

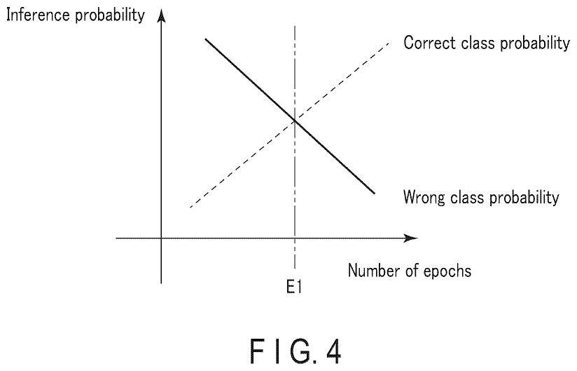

FIG. 4 is a diagram showing a relationship between transition of the inference probability and the number of truncated updates E1. In FIG. 4, the vertical axis represents the inference probability, and the horizontal axis represents the number of epochs. The correct class probability represents the inference probability of a class that matches the true label of the sample (correct class), and the wrong class probability represents the inference probability of a class that does not match the true label of the sample (wrong class). It is assumed that the initial label is labeled to the wrong class. At the start of learning (number of epochs=0), the one-hot representation of the initial label is 1 for the wrong class and 0 for the correct class. As learning progresses under the assumption of generalizability, fitting to the correct class progresses, and the correct class probability increases and the wrong class probability decreases accordingly. Eventually, the correct class probability exceeds the wrong class probability. At this time, the correct class probability is higher than the wrong class probability, and the one-hot representation of the pseudo label is 0 for the wrong class and 1 for the correct class. The number of epochs in which the correct class probability and the incorrect class probability are reversed is the number of truncated updates E1. That is, the one-hot representation of the pseudo label changes from the one-hot representation of the initial label at the number of truncated updates E1.

Therefore, the update determination unit 23 calculates, as the number of truncated updates, a specific number of updates at which a class corresponding to the maximum value among a plurality of component values constituting a target label vector before update (hereinafter, target label component values) changes to a class corresponding to the maximum value among a plurality of component values constituting an inference probability vector (hereinafter, inference probability component values). Specifically, the number of truncated updates t can be expressed by the following expression (2) under the assumption of stationarity, where the inference probability vector does not change.

$$τ = {log}_{1 - m} ( δ p / ( δ p + δ y ) ) \qquad ( 2 )$$

$$δ p = {p}_{{c}_{p}} - {p}_{{c}_{y}}$$

$$δ y = {y}_{{c}_{y}} - {y}_{{c}_{p}}$$

$${c}_{p} = {arg max}_{c} {p}_{c}$$

$${c}_{y} = {arg max}_{c} {y}_{c}$$

In the expression (2), cₚ is a class that takes the maximum value among a plurality of inference probability component values pc constituting an inference probability vector p. In other words, cₚ is an inference probability component value of a class in which the one-hot representation of the inference probability vector p is 1. In addition, c_{y} is a class that takes the maximum value among a plurality of target label component values y_{c} constituting the target label vector y before update. In other words, c_{y} is an inference probability component value of a class in which the one-hot representation of the target label vector y before update is 1.

Furthermore, op is a value obtained by subtracting p_{cy} from p_{cp}, that is, a value obtained by subtracting an inference probability component value p_{cy} of a class c_{y} among the inference probability component values p_{c} constituting the inference probability vector p from an inference probability component value p_{cp} of a class cₚ among the inference probability component values p_{c} constituting the inference probability vector p. Similarly, δ_{y} is a value obtained by subtracting y_{cp} from y_{cy}, that is, a value obtained by subtracting a target label component value y_{cp} of the class cₚ among a plurality of target label component values y_{c} constituting the target label vector y before update from a target label component value y_{cy} of the class c_{y} among the target label component values y_{c} constituting the target label vector y before update.

The update determination unit 23 calculates the number of truncated updates at any number of updates. As an example, the number of truncated updates is only required to be calculated at the number of updates designated in advance by a user. Empirically, it is preferable that the number of updates designated in advance by the user is determined to be less than the number of truncated updates. In addition, the update determination unit 23 may calculate the number of truncated updates for each first sample. At this time, the update determination unit 23 compares the number of truncated updates with the current number of updates for each first sample, updates the target label related to the first sample if the current number of updates has not reached the number of truncated updates, and corrects the target label related to the first sample to a one-hot vector if the current number of updates has reached the number of truncated updates.

According to the present embodiment, first, since the optimal learning rate with a high learning rate is used, it is possible to update the label using only generalizable features that are not overfitted to noise. Label update with such a learning behavior considered enables us to obtain a target label with higher precision (optimal target label). Second, an appropriate number of truncated updates enables us to suppress the deterioration in precision of the target label due to repeated updates and to maximize the performance of the exponential moving average label update. Third, the number of truncated updates can be automatically determined only by the inference probability and the pseudo label at a certain epoch, and different numbers of truncated updates can be set according to individual samples. That is, it is possible to automatically perform label update according to each sample, and the number of updates therefor is also automatically determined according to each sample. As a result, it is possible to greatly simplify a complicated operation of adjusting the number of truncated updates according to each sample.

With the above advantages, in the present embodiment, it is possible to appropriately correct wrong labels at a lower cost compared to Non-Patent Literature 1. Therefore, it is possible to perform robust learning even for a data set containing wrong labels, and it is also possible to provide feedback to the training work by displaying a sample with a wrong label.

The process by the label correction unit 20 is basically assumed to be performed at a high learning rate (optimal learning rate) at which generalizable features can be obtained. Therefore, the learning rate estimation unit 30 is provided independently of the label correction unit 20.

The optimal learning rate, which is a learning rate high enough to acquire generalizable features, can be determined semi-automatically. The determination of the optimal learning rate utilizes the property that the optimal learning rate is not strongly dependent on the intensity of noise. For example, it is presumed that there is a noisy dataset and that very strong noise is artificially added to its labels. If the artificial label noise is significantly stronger than the original label noise, the accuracy measured with the label before the injection of artificial noise can be regarded as the accuracy measured with an effectively noise-free label. By comparing the accuracies of the two, it is possible to observe overfitting to noise, that is, the deviation of the accuracies between the two. Therefore, if supervised learning is performed by varying the learning rate, the learning rate at which overfitting occurs can be estimated. The optimal learning rate is determined based on the learning rate. Hereinafter, the learning rate estimation unit 30 will be described in detail.

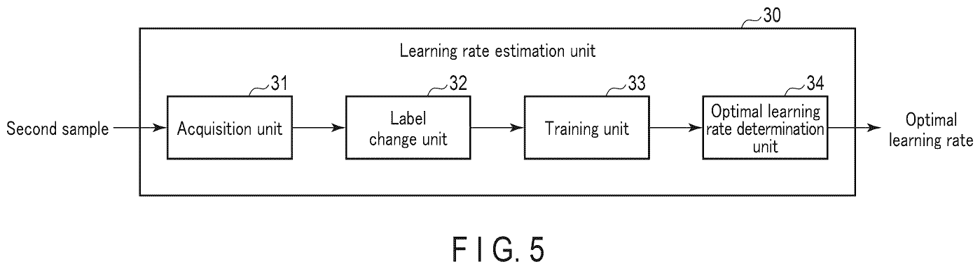

FIG. 5 is a diagram showing a functional configuration example of the learning rate estimation unit 30. As shown in FIG. 5, the learning rate estimation unit 30 includes an acquisition unit 31, a label change unit 32, a training unit 33, and an optimal learning rate determination unit 34.

As shown in FIG. 5, the acquisition unit 31 acquires a second sample. The second sample means data to be input to a second classification model, and contains any format of data applicable to the classification model, such as images, video, audio, text, sensor output, and the like.

The label change unit 32 changes an initial label of the second sample acquired by the acquisition unit 31 to an artificial label, which is a label artificially changed from the initial label.

The training unit 33 uses the artificial label obtained by the label change unit 32 as a teacher to perform supervised learning on a second deep learning model (second classification model) that processes the classification problem at a plurality of different learning rates.

The optimal learning rate determination unit 34 determines a specific learning rate capable of avoiding overfitting (hereinafter, an optimal learning rate) based on a change in behavior of an output evaluation index at a plurality of learning rates. The output evaluation index is a second model output from the second classification model by applying the second sample to the second classification model, or an error of the second model output. Specifically, the optimal learning rate determination unit 34 determines the optimal learning rate based on the degree of deviation between a curve representing a change in a first output evaluation index with a change in the number of updates and a curve representing a change in a second output evaluation index. The first output evaluation index is an error between an initial label of the second sample and a second model output (inference probability). The second output evaluation index is an error between an artificial label of the second sample and a second model output. As an index for evaluating the error, a value of a loss function is used. The loss value can be used similarly to the accuracy. For example, the optimal learning rate determination unit 34 determines a learning rate at which the deviation is below a reference value as the optimal learning rate.

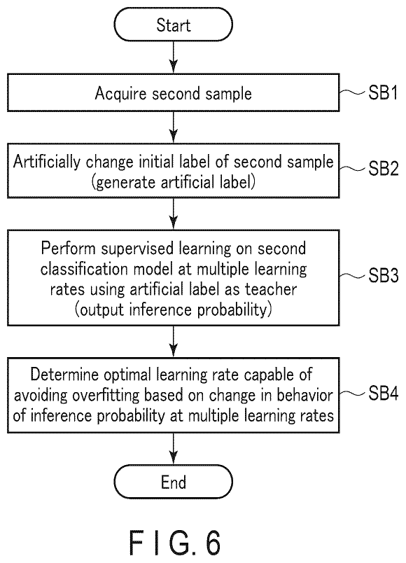

FIG. 6 is a flowchart of an example of a learning rate determination process by the learning rate estimation unit 30. As shown in FIG. 6, first, the acquisition unit 31 acquires a second sample (step SB1). The second sample is obtained from a second learning data set containing a plurality of second samples. The second samples are each provided with a target label. It is assumed that the second learning data set is a noisy data set containing wrong labels. However, it is assumed that the intensity of the label noise is not strong. As an example, it is assumed that 80% of the second learning data set are true labels and the remaining 20% are wrong labels. The second samples may be the same as or different from the first samples.

When step SB1 is performed, the label change unit 32 artificially changes the initial labels of the second samples acquired in step SB1 (step SB2). In step SB2, the label change unit 32 artificially randomizes the initial labels, thereby creating a second learning data set with very strong label noise. Specifically, the label change unit 32 artificially changes true labels to wrong labels and wrong labels to true labels for the second samples. The artificially changed initial labels are referred to as artificial labels. That is, the second samples contain initial labels and artificial labels.

When step SB2 is performed, the training unit 33 performs supervised learning on a second classification model at a plurality of learning rates using the artificial labels obtained in step SB2 as a teacher (step SB3). The second classification model is assumed to be a deep neural network having any network layer such as a fully connected layer, a convolutional layer, a self-attention layer, and/or a pooling layer. The second classification model is untrained. The second classification model and the first classification model may have the same or different network structures. The learning rates may be arbitrarily designated by the user.

As an example, the training unit 33 performs supervised learning on the second classification model using the artificial label as a teacher for each of a plurality of preset learning rates. The training unit 33 inputs the second samples to the second classification model and applies a forward propagation process according to the network structure of the second classification model to the input second samples, thereby calculating the inference probability corresponding to the second samples. The inference probability calculated in the process of supervised learning is stored in association with the number of epochs. As another example, the training unit 33 may perform supervised learning using cosine annealing that changes a learning rate in a cosine curve shape according to the number of epochs.

When step SB3 is performed, the optimal learning rate determination unit 34 determines an optimal learning rate capable of avoiding overfitting based on a change in behavior of the inference probability at a plurality of learning rates (step SB4). The optimal learning rate determination unit 34 determines the optimal learning rate based on the degree of deviation between a first learning curve representing a change in a first output evaluation index with a change in the number of updates and a second learning curve representing a change in a second output evaluation index. The first output evaluation index is a loss value given by the initial label and the inference probability, and the second output evaluation index is a loss value given by the artificial label and the inference probability.

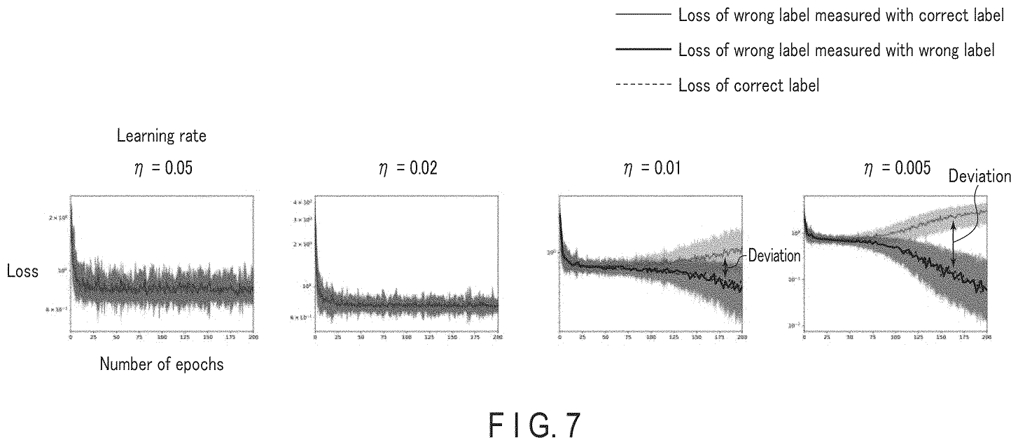

FIG. 7 is a diagram showing behavior of an inference probability at a plurality of learning rates. The graphs shown in FIG. 7 represent the change in loss with the number of epochs at the learning rates n=0.05, 0.02, 0.01, and 0.005, respectively, in order from the left. The vertical axis of each graph represents loss, and the horizontal axis represents the number of epochs. The thin line represents the loss of the wrong label measured with the correct label, that is, the first learning curve related to the first output evaluation index. The first learning curve (thin line) means the loss measured with the initial label. The thick line represents the loss of the wrong label measured with the wrong label, that is, the second learning curve related to the second output evaluation index. The second learning curve (thick line) means the loss measured with the artificial label. The dotted line represents the loss of the correct label, that is, a third learning curve.

As shown in FIG. 7, the second learning curve (thick line) behaves similarly to the third learning curve (dotted line) regardless of the learning rate n. In a case where the learning rate is relatively large, such as the learning rate n=0.05 or 0.02, overfitting to label noise does not occur, and the first learning curve (thin line) and the second learning curve (thick line) behave similarly. However, in a case where the learning rate is relatively small, such as the learning rate n=0.01 or 0.005, overfitting to label noise occurs, and the first learning curve (thin line) and the second learning curve (thick line) deviate from each other as the learning progresses (as the number of epochs increases).

The optimal learning rate determination unit 34 determines the optimal learning rate based on the degree of deviation between the first learning curve and the second learning curve. As an example, the optimal learning rate determination unit 34 measures, for each of the learning rates, the deviation between the first learning curve and the second learning curve at a predetermined number of epochs (hereinafter, the number of measured epochs), that is, the difference in loss. The number of measured epochs means the number of epochs that is empirically recognized as causing a significant deviation if overfitting occurs. The number of measured epochs can be arbitrarily set according to an instruction of the user or the like. Next, the optimal learning rate determination unit 34 generates a graph (deviation-learning rate graph) plotting the measured deviation in a two-dimensional coordinate space defined by the learning rate and the deviation. The deviation-learning rate graph means a graph related to a curve representing a change in deviation for each of the learning rates.

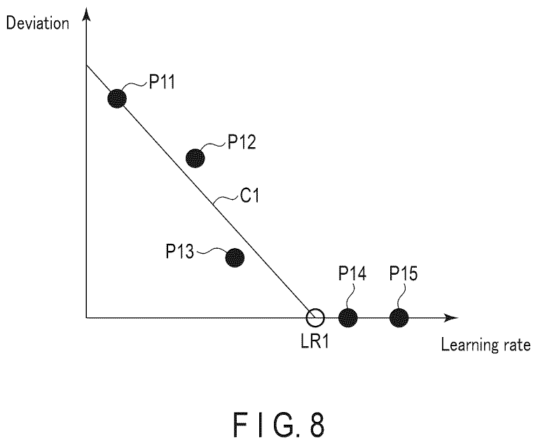

FIG. 8 is a diagram showing a deviation-learning rate graph. As shown in FIG. 8, in the deviation-learning rate graph, the horizontal axis is defined as the learning rate, and the vertical axis is defined as the deviation. In the deviation-learning rate graph shown in FIG. 8, five measurement points P11 to P15 are plotted as an example. The optimal learning rate determination unit 34 calculates a fitting curve C1 based on the five measurement points P11 to P15, and calculates a point at which the fitting curve C1 intersects the horizontal axis as an optimal learning rate LR1. That is, the learning rate at which the deviation becomes zero (reference value) is calculated as the optimal learning rate LR1. Alternatively, the optimal learning rate determination unit 34 may calculate a learning rate higher than the intersection by a margin value as the optimal learning rate. The margin value can be set to any value. The fitting curve C1 may be a linear function or a quadratic or higher-order function. Note that the optimal learning rate LR1 is not limited to the learning rate at which the deviation becomes zero, and is only required to be set to a learning rate that is equal to or less than an arbitrary reference value, such as a minimum value, among the deviations obtained at the learning rates. The reference value is only required to be set to an upper limit value of deviation for obtaining a learning rate capable of avoiding overfitting.

Note that the optimal learning rate determination unit 34 may determine the optimal learning rate in accordance with an instruction of the user. For example, the display control unit 50 displays the deviation-learning rate graph generated by the optimal learning rate determination unit 34 on the display device 15. The measurement points are preferably drawn in the deviation-learning rate graph, but the fitting curve C1 may or may not be drawn. The input device 13 designates the optimal learning rate in the displayed deviation-learning rate graph according to the instruction of the user. For example, the user analyzes the displayed deviation-learning rate graph and designates a position corresponding to a desired learning rate in the deviation-learning rate graph via the input device 13. The optimal learning rate determination unit 34 determines the learning rate corresponding to the designated position as the optimal learning rate. For example, a desired position on the horizontal axis can be designated. The learning rate corresponding to the designated position is determined as the optimal learning rate. At this time, designatable positions are not limited to those corresponding to the learning rates at which the measurement points P11 to P15 are obtained, and the designated position may be the one corresponding to a learning rate at which the measurement points P11 to P15 are not obtained.

As another example, the display control unit 50 may display a plurality of graphs corresponding to a plurality of learning rates, respectively, shown in FIG. 7. In this case, the user designates a graph corresponding to a desired learning rate via the input device 13. The optimal learning rate determination unit 34 determines the learning rate corresponding to the designated graph as the optimal learning rate.

Another method of determining the optimal learning rate will be described. The optimal learning rate determination unit 34 may consider the change of labels by the label change unit 32. Focusing on the sample whose target labels match before and after the change, the first output evaluation index may be the similarity between the target label and the maximum inference probability class of specified samples. Focusing on the sample whose target labels do not match before and after the label change and the target label before the change, the second output evaluation index may be the similarity between the target label and the maximum inference probability class of specified samples. Then the optimal learning rate is determined by a learning rate at which the two degrees of agreement deviate from each other or a learning rate higher than the learning rate by a margin value. As another method, the optimal learning rate determination unit 34 may measure the difference of the maximum inference probability class between lower and higher learning rates. In this method, the optimal learning rate determination unit 34 focuses on the sample whose target labels do not match before and after the change and each target label, and searches for a learning rate where the maximum inference probability class changes. The similarity may be calculated by counting and averaging binary determination results similarly to the accuracy, or by using a loss function, typically a cross-entropy value. These methods estimate that such behavior occurs at a learning rate where the model overfits to the noisy label.

When step SB4 is performed, the learning rate determination process by the learning rate estimation unit 30 is terminated.

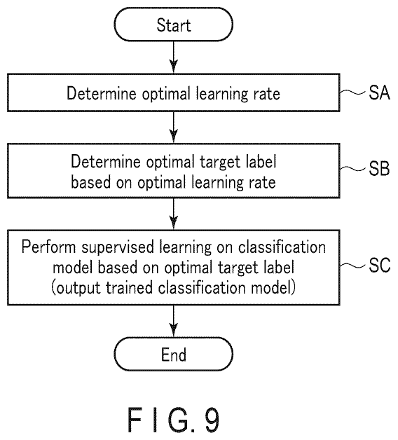

FIG. 9 is a flowchart showing an example of an overall process by the machine learning apparatus 1. The overall process shown in FIG. 9 is started by the processor 11 reading and executing a program. As shown in FIG. 9, first, the learning rate estimation unit 30 determines an optimal learning rate (step SA). When step SA is performed, the label correction unit 20 determines an optimal target label based on the optimal learning rate determined in step SA (step SB). As described above, the label correction unit 20 outputs a one-hot label, which is a hard-labeled training label at the number of truncated updates as the optimal target label.

When step SB is performed, the label-noise-resistant training unit 40 performs supervised learning on a third classification model based on the optimal target label determined in step SB (step SC). The third classification model is assumed to be a deep neural network having any network layer such as a fully connected layer, a convolutional layer, a self-attention layer, and/or a pooling layer. The third classification model is untrained. The third classification model and the first and second classification models may have the same or different network structures.

Since the label-noise-resistant training unit 40 performs supervised learning using the optimal target label as a teacher, it is possible to perform high-quality supervised learning. At this time, the label-noise-resistant training unit 40 is only required to perform supervised learning on the third classification model at any learning rate. As an example, the label-noise-resistant training unit 40 may perform supervised learning at a learning rate smaller than the optimal learning rate. In supervised learning with low label noise, overfitting to target labels at a low learning rate contributes to improve generalization performance, and therefore, it is valuable to continue learning until a low learning rate is reached. The completion of supervised learning outputs a trained classification model. As another example, the learning rate may be changed according to the number of epochs, such as cosine annealing.

When step SC is performed, the overall process by the machine learning apparatus 1 is terminated.

The above embodiment is an example, and various processes can be added, deleted, and/or changed. Hereinafter, modifications of the present embodiment will be described.

### (First Modification)

In the above embodiment, the network structure of each classification model and the type of sample are not particularly limited. The classification model may have a convolutional neural network structure or a transformer structure. However, it is assumed that a target label can be added to each sample. This is most typical in a case where a target label is added in advance, but a semi-supervised sample in which a target label is added to part of a data set may also be applicable. Similar processes can be achieved by performing a certain degree of learning using only samples with target labels. Furthermore, even in an unsupervised situation where target labels are not added to all samples, a pseudo label may be added by performing standard unsupervised learning such as SimCLR. Therefore, it is not limited to whether each sample has a target label.

The present embodiment may be combined with unsupervised learning. That is, unsupervised learning, such as SimCLR or MoCo, is first performed on a data set to be used. Next, classification, that is, generation of a pseudo label is performed by a clustering algorithm, such as k-means or DBSCAN. Accordingly, by using the obtained pseudo label, it is possible to determine the optimal learning rate and update the target label.

The same can be applied to more special label settings. For example, the present embodiment is also applicable to positive-unlabeled (PU) learning in which some samples are known to be positive but others are unlabeled. For example, if a positive or negative target label is randomly assigned to an unlabeled sample, it is possible to determine the optimal learning rate and update the target label. However, since randomness is involved twice in determining the optimal learning rate, it is preferable to assign target labels several times for a statistical process.

### (Second Modification)

In a case where it is known that samples without noise are contained in part of samples with strong noise, the optimal learning rate can be determined with higher precision by using only the samples without noise. Such a situation corresponds to a case where there are a large number of samples labeled by non-experts and some of them are labeled by experts.

In a case where the intensity of noise is known to some extent, that is, in a case where the percentage of wrong labels in the data set is known, the label correction unit 20 may assign priorities to the samples whose labels are to be updated, and update only the target labels of the samples within the specified top percentage of priority. The specified top percentage may be estimated from the labeling result by experts and/or the non-experts, or may be estimated from the recall rate during actual operation.

### (Third Modification)

The update unit 24 according to the above embodiment updates the target label based on the inference probability. The update unit 24 according to a third modification may calculate an integrated label of a first label for a first sample to be corrected among the first sample and other first samples different from the first sample to be corrected, and update the label to be corrected based on the calculated integrated label and the first model output. Hereinafter, the update unit 24 according to a third modification will be described. Note that it is assumed that the first model output is the inference probability.

Specifically, the update unit 24 identifies a plurality of samples whose model output is similar to the target sample to be corrected as the other first samples, and calculates statistical values of a plurality of target labels corresponding to a plurality of first samples, respectively, as the target label for the other first samples. As an example, the update unit 24 calculates an average value of the first target labels added to k samples indicating the inference probability close to the inference probability of the first sample to be corrected, and updates the target label using the calculated average value. This method is called a nearest neighbor label average. The average value may be a weighted average value according to the distance instead of a simple average value, or may be an average value of the inference probability instead of the target label. In addition, not only the Euclidean distance but also Jensen-Shannon divergence and symmetric Kullback-Leibler divergence may be used to measure the distance. The distance may be calculated based on the feature vector instead of the inference probability. As a similar method, the update unit 24 may calculate the target label of each sample based on a Gaussian Mixture Model.

### (Fourth Modification)

The update unit 24 according to the above embodiment updates the target label based on the moving average. However, the present embodiment is not limited thereto. For example, if the one-hot vector of the target label before update is different from the one-hot vector of the inference probability, the update unit 24 calculates a moving average of the target label before update and the inference probability as the target label after update. If they are the same, the update unit 24 calculates a moving average of the target label before update and the one-hot vector of the inference probability as the target label after update. As a result, even if there is an error in the estimation of the number of truncated updates, it is possible to stably perform label update. Note that, as the moving average, a simple moving average, a weighted moving average, an exponential moving average, or any other moving average can be used.

### (Fifth Modification)

The update determination unit 23 according to the above embodiment calculates the number of truncated updates based on the inference probability at a certain epoch. However, the present embodiment is not limited thereto. The update determination unit 23 according to a fifth modification calculates a moving average at the number of truncated updates temporarily calculated at the current number of updates and the number of truncated updates calculated at the number of updates prior to the current number of updates as the number of truncated updates related to the current number of updates. Note that, as the moving average, a simple moving average, a weighted moving average, an exponential moving average, or any other moving average can be used.

For example, the update determination unit 23 may calculate, as the number of truncated updates at the current number of updates, a moving average of the number of truncated updates starting from the number of truncated updates calculated at a certain number of updates and calculated at the current number of updates in subsequent numbers of updates, and the number of truncated updates calculated up to the previous update. As a result, it is possible to resolve the instability derived from referring only to a specific number of updates. At this time, a constant value may be assigned to the number of truncated updates at the number of updates at the start of the calculation of the number of truncated updates in such a manner that the number of label updates exceeds a certain number.

### (Sixth Modification)

The update determination unit 23 according to the above embodiment calculates the number of truncated updates based on the moving average and generalizability. However, the present embodiment is not limited thereto. For example, the update determination unit 23 according to a sixth modification may calculate a difference between the target label at the current number of updates and the target label at the next number of updates, and calculate the number of truncated updates based on the calculated difference. As described above, since the number of truncated updates means when the hard label of the target label switches from the hard label of the initial label, the update determination unit 23 may set the current number of updates to the number of truncated updates if the difference is larger than a threshold, for example. This method can also be used in situations other than label update based on a moving average.

In the above description, it is assumed that the number of truncated updates is when the hard label switches, but it may perform it, assuming that the number of truncated updates has sufficiently approached the hard label. For example, the update determination unit 23 may terminate the label update if Jensen-Shannon divergence from the hard label is below a threshold.

### (Seventh Modification)

The update determination unit 23 according to the above embodiment does not resume the label update once the number of updates reaches the number of truncated updates. However, the present embodiment is not limited thereto. The update determination unit 23 according to a seventh modification may resume the update at each constant number of epochs. The number of epochs until the resume of the update is preferably set to a value greater than 1/m, which is a typical number of updates calculated from a moving average parameter m. By resuming the label update, it is possible to obtain an appropriate training label following the classification model even in a case where the classification model varies significantly during learning.

### (Eighth Modification)

The update determination unit 23 according to the above embodiment does not designate the percentage of data labeled with different labels between the initial label and the optimal target label, that is, the relabeling rate. However, the present embodiment is not limited thereto. The update determination unit 23 according to an eighth modification may terminate the label update at the time when the relabeling rate reaches a designated relabeling rate. For example, the update determination unit 23 calculates the degree of matching between the initial label containing label noise and the current target label (the pseudo label after label update), and determines that the label update is not terminated and continues the label update if a change in the degree of matching is not smaller than a threshold. On the other hand, if a change in the degree of matching becomes smaller than the threshold, the update determination unit 23 determines that the label update is terminated. That is, the number of updates at which a change in the degree of matching becomes smaller than the threshold corresponds to the number of truncated updates. If the percentage of wrong labels is known, the determination may be made based on how close the degree of matching is to the relabeling rate corresponding to the percentage. According to the eighth modification, it is possible to terminate the label update at a more appropriate time by adding another termination determination.

### (Ninth Modification)

In the above embodiment, the optimal learning rate determination unit 34 uses the second model output, which is the output of the second classification model, as the output evaluation index to be used to determine the optimal learning rate. However, the present embodiment is not limited thereto. The optimal learning rate determination unit 34 according to a ninth modification uses an error of the second model output as the output evaluation index. Specifically, the optimal learning rate determination unit 34 applies the second classification model to the second sample to calculate the inference probability, which is the second model output, and calculates an error between the calculated inference probability and the target label. The error may be a value of the loss function given by the inference probability and the target label, or a cross entropy based on the loss. Since only one cross entropy is calculated for the inference probability vector and the target label vector, it is possible to easily determine the optimal learning rate as compared with the inference probability obtained for each class.

### (Effects)

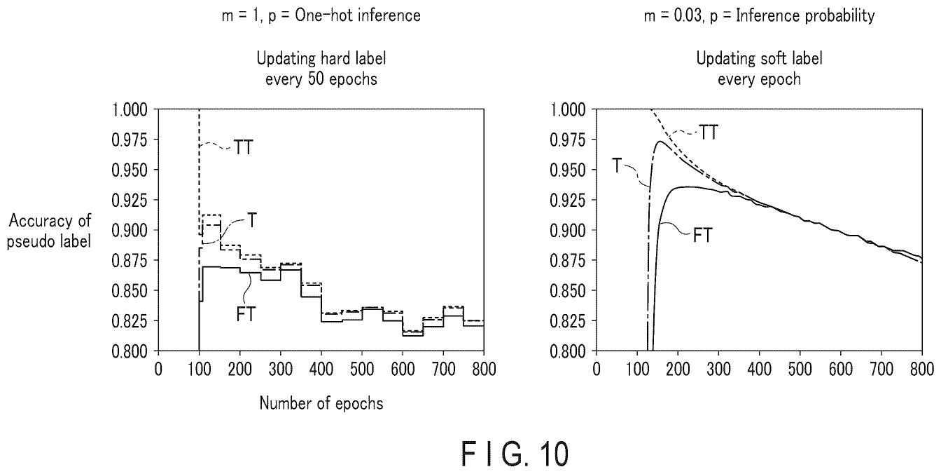

FIG. 10 is a diagram showing transition of accuracy of a pseudo label according to a comparative example. In the comparative example, the accuracy in a case where the pseudo label is updated at predetermined intervals by the exponential moving average of the above equation (1) is verified under a constant learning rate. In each of the left diagram and the right diagram in FIG. 10, the vertical axis represents the accuracy of the pseudo label, and the horizontal axis represents the number of epochs. The left diagram in FIG. 10 shows the transition of the accuracy in a case where the hard label (one-hot label) was used for the pseudo label, m=1, and the pseudo label was updated every 50 epochs. The right diagram shows the transition of the accuracy in a case where the soft label was used for the pseudo label, m=0.03, and the pseudo label was updated every epoch. A curve TT represents the accuracy of the pseudo label with the correct label, a curve FT represents the accuracy of the pseudo label with the wrong label, and a curve T represents the average accuracy of the pseudo label with all labels. Note that CIFAR-10 was used as the data set, and ResNet-18 was used as the classification model. In addition, 20% of the samples were equally misclassified into other classes.

Comparing the left diagram and the right diagram in FIG. 10, the accuracy of the update of the soft label is improved as a whole as compared with the update of the hard label. However, it can be seen that the precision of the pseudo label deteriorates and the accuracy decreases with the number of epochs.

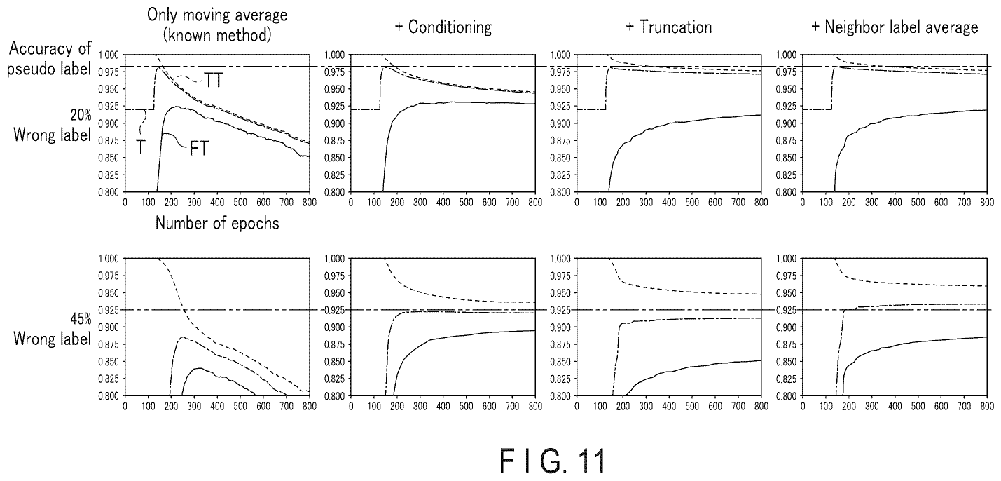

FIG. 11 is a diagram showing transition of the accuracy of the pseudo labels according to the present embodiment. The first column from the left in FIG. 11 is the accuracy in a case where the pseudo label was updated at predetermined intervals by only the moving average, that is, the exponential moving average of the above expression (1), and is similar to the comparative example in FIG. 10. The second column is obtained by adding conditioning to the first column (moving average). The conditioning was performed without truncation using the method according to the fourth modification. The third column is obtained by adding truncation to the second column (moving average+conditioning). The truncation is an embodiment of truncating the label update according to the number of truncated updates by the label correction unit 20. The fourth column is obtained by adding the nearest neighbor label average to the third column (moving average+conditioning+truncation (fourth modification)) according to the third modification. Note that CIFAR-10 was used as the data set, and ResNet-18 was used as the classification model. The learning rate is the optimal learning rate. In the upper part of FIG. 11, the percentage of wrong labels in the data set is 20%, and noise is relatively weak. In the lower part, the percentage of wrong labels in the data set is 45%, and noise is relatively strong.

Comparing the first column with the second to fourth columns in FIG. 11, in the present embodiment (the second to fourth columns), a decrease in the accuracy with the number of epochs is generally suppressed as compared with the comparative example (the first column). In particular, it can be seen that the method in the third column is effective for weak noise, the method in the fourth column is effective for strong noise, and the method in the second column is effective for both weak noise and strong noise.

Thus, according to the above embodiment, it is possible to improve the reliability of labels to be used for learning of a deep learning model that processes a classification problem.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning apparatus comprising a processor, wherein
the processor is configured to:
acquire, by applying a first sample to a first deep learning model that processes a classification problem, a first model output containing an inference probability and/or a feature vector output from the first deep learning model;
determine whether an update of a label to be used as a teacher in learning of the first deep learning model is required, based on the first model output and/or the label; and
update the label based on the first model output and a label at a current number of updates if it is determined that the update of the label is required, and terminate the update of the label if it is determined that the update of the label is not required.

2. The machine learning apparatus according to claim 1, wherein
the processor is further configured to:
calculate, based on the first model output and/or the label, a first number of updates related to a stop of the update of the label; and
determine, based on a comparison between the current number of updates and the first number of updates, whether the update of the label is required.

3. The machine learning apparatus according to claim 2, wherein the processor is configured to calculate, as the first number of updates, a specific number of updates at which a class corresponding to a maximum value among a plurality of component values constituting a vector before updating the label changes to a class corresponding to a maximum value among a plurality of component values constituting an inference probability vector, the inference probability vector being the first model output.

4. The machine learning apparatus according to claim 3, wherein the processor is configured to calculate the first number of updates based on the specific number of updates calculated at the current number of updates and the specific number of updates calculated at the number of updates prior to the current number of updates.

5. The machine learning apparatus according to claim 2, wherein the processor is configured to calculate the first number of updates based on a difference between the label at a predetermined number of updates and the label at the number of updates prior to the predetermined number of updates.

6. The machine learning apparatus according to claim 1, wherein the processor is configured to, if it is determined that the update of the label is required, terminate the update of the label, and correct the label at the current number of updates to a hard-labeled one-hot label.

7. The machine learning apparatus according to claim 1, wherein the processor is configured to, if it is determined that the update of the label is required, calculate a label at the next number of updates based on the first model output at the current number of updates and the label at the current number of updates.

8. The machine learning apparatus according to claim 1, wherein
the processor is further configured to:
determine whether the update of the label is required for each of a plurality of the first samples; and
update the label for each of the first samples.

9. The machine learning apparatus according to claim 7, wherein the processor is configured to calculate an integrated label of a label for a first sample to be corrected among a plurality of the first samples and a label for another first sample different from the first sample to be corrected, and update the label to be corrected based on the integrated label and the first model output.

10. The machine learning apparatus according to claim 9, wherein the processor is configured to identify a plurality of samples whose model output is similar to the sample to be corrected as the other first samples, and calculate statistical values of a plurality of labels corresponding to the first samples, respectively, as the label for the other first samples.

11. The machine learning apparatus according to claim 1, wherein
the processor is further configured to:
acquire a second sample;
change an initial label of the second sample to an artificial label, the artificial label being a label obtained by artificially changing the initial label;
perform supervised learning at a plurality of different learning rates on a second deep learning model that processes a classification problem using the artificial label as a teacher; and
determine a specific learning rate capable of avoiding overfitting based on a change in behavior of an output evaluation index among the learning rates, and
the output evaluation index is a second model output from the second deep learning model by applying the second sample to the second deep learning model, or an error of the second model output.

12. The machine learning apparatus according to claim 11, wherein
the processor is configured to determine the specific learning rate based on a degree of deviation between a curve representing a change in a first output evaluation index with a change in the number of updates and a curve representing a change in a second output evaluation index,
the first output evaluation index is an error between the initial label of the second sample, and an inference probability, the inference probability being the second model output, and
the second output evaluation index is an error between the artificial label of the second sample, and the inference probability being the second model output.

13. The machine learning apparatus according to claim 12, wherein the processor is configured to acquire the first model output at the specific learning rate.

14. The machine learning apparatus according to claim 12, wherein the processor is configured to determine a learning rate at which the deviation is below a reference value as the specific learning rate.

15. The machine learning apparatus according to claim 12, wherein
the processor is further configured to:
display a graph related to a curve representing a change in the deviation for each of the learning rates on a display device; and
designate the specific learning rate for the displayed graph according to an instruction of a user.

16. The machine learning apparatus according to claim 1, wherein
the processor is further configured to:
terminate, if it is determined that the update of the label is not required, the update of the label, and generate a one-hot label by hard-labeling the label at the current number of updates; and
perform supervised learning on a third deep learning model that processes a classification problem using the one-hot label as a teacher.

17. A machine learning method comprising:
acquiring, by a processor, a first model output containing an inference probability and/or a feature vector output from a first deep learning model by applying a first sample to the first deep learning model that processes a classification problem;
determining, by the processor, whether an update of a label to be used as a teacher in learning of the first deep learning model is required, based on the first model output and/or the label; and
updating, by the processor, the label based on the first model output and a label at a current number of updates if it is determined that the update of the label is required, and terminating the update of the label if it is determined that the update of the label is not required.

18. A non-transitory computer readable storage medium including computer executable instructions, wherein the instructions, when executed by a processor, cause the processor to perform operations comprising:
acquiring, by applying a first sample to a first deep learning model that processes a classification problem, a first model output including an inference probability and/or a feature vector output from the first deep learning model;
determining, based on the first model output and/or the label, whether an update of a label to be used as a teacher in learning of the first deep learning model is required; and
updating the label based on the first model output and a label of a current number of updates if it is determined that the update of the label is required, and terminating the update of the label if it is determined that the update of the label is not required.
